(19) United States
(12) Patent Application Publication
(10) Pub. No.: US 2010/0162615 A1
(43) Pub. Date: Jul. 1, 2010

(54) Swatter for killing a flying insect

(75) Inventor: Marc A. Keralla, Carrollton, TX (US)

Correspondence Address: W. THOMAS TIMMONS, 1320 PRUDENTIAL DRIVE, SUITE 208, DALLAS, TX, 75235-4117, US

(73) Assignee: Base4 Group, Inc., a corporation of State of Delaware

(21) Appl. No.: 12/317,607

(22) Filed: Dec. 26, 2008

(51) Int. Cl. A01M 1/22; A01M 3/02

(52) U.S. Cl. 43/112; 43/137

(57) ABSTRACT

An apparatus according to the present invention for hitting a flying insect, includes the combination of at least one electrically conducting net for hitting the flying insect, a source of electric power connected to the at least one electrically conducting net a counter, a transducer coupled to the at least one electrically conducting net and to the counter, for indicating to the counter when the at least one electrically conducting net hits the flying insect, and a display coupled to the counter for indicating the number of hits. The at least one electrically conducting net is provided sufficient electrical power to kill the flying insect upon contact. A preferred form of the apparatus further includes a frame for holding the at least one electrically conducting net and a handle for manually holding the apparatus, wherein the frame extends from one end of the handle. In a preferred form of the apparatus, the counter includes a processor, and the apparatus further includes a manual reset coupled to the processor. When the manual reset is activated, the display is reset to zero.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to methods and apparatus for detecting and recording the hitting of an object and, in one of its aspects, to games and equipment for playing paddle games.

2. Description of Related Art

There are many electric insect swatters. They all have a tennis racket shape with electrically conducting nets which kill flying insects on contact.

### BRIEF SUMMARY OF THE INVENTION

An apparatus according to the present invention for hitting a flying insect, includes the combination of at least one electrically conducting net for hitting the flying insect, a source of electric power connected to the at least one electrically conducting net a counter, a transducer coupled to the at least one electrically conducting net and to the counter, for indicating to the counter when the at least one electrically conducting net hits the flying insect, and a display coupled to the counter for indicating the number of hits. The at least one electrically conducting net is provided sufficient electrical power to kill the flying insect upon contact.

A preferred form of the apparatus further includes a frame for holding the at least one electrically conducting net and a handle for manually holding the apparatus, wherein the frame extends from one end of the handle.

In a preferred form of the apparatus, the counter includes a processor, and the apparatus further includes a manual reset coupled to the processor. When the manual reset is activated, the counter is reset to zero.

A swatter according to the present invention for use by a player for hitting a flying insect, includes the combination of a handle for the player to manually hold the swatter, at least one electrically conducting net forming at least one face of the swatter, for hitting the flying insect, a counter, a transducer coupled to the at least one electrically conducting net and to the counter, for indicating to the counter when the at least one electrically conducting net hits the flying insect; and a display coupled to the counter for indicating the number of hits.

In a preferred form of the swatter, the counter includes a processor, and the swatter further includes a manual reset coupled to the processor. When the manual reset is activated, the counter is reset to zero. A source of electric power for operation of the processor, the display and the at least one electrically conducting net is located inside the handle. The display and the manual reset are also located on the handle.

These and other objects, advantages and features of this invention will be apparent from the following description taken with reference to the accompanying drawing, wherein is shown a preferred embodiment of the invention.

### BRIEF DESCRIPTION OF THE SEVERAL VIEWS OF THE DRAWING

FIG. 1 is a front elevation view of a swatter according to the present invention for hitting a flying insect; and

FIG. 2 is a diagram of the electric circuit for the swatter of FIG. 1.

### DETAILED DESCRIPTION OF THE INVENTION

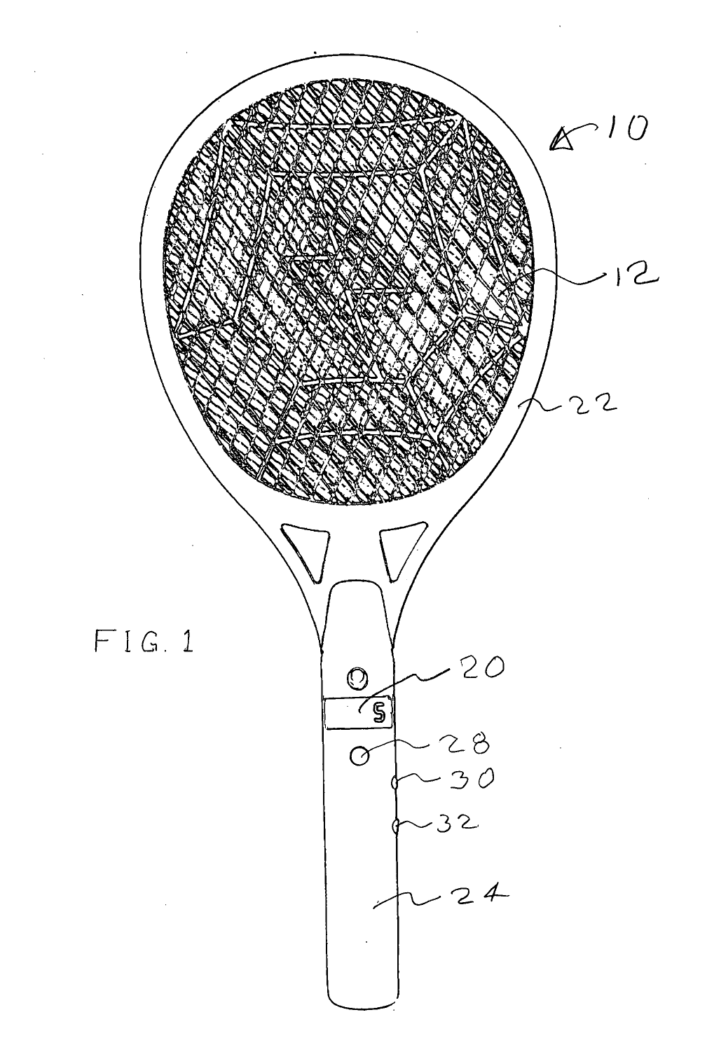

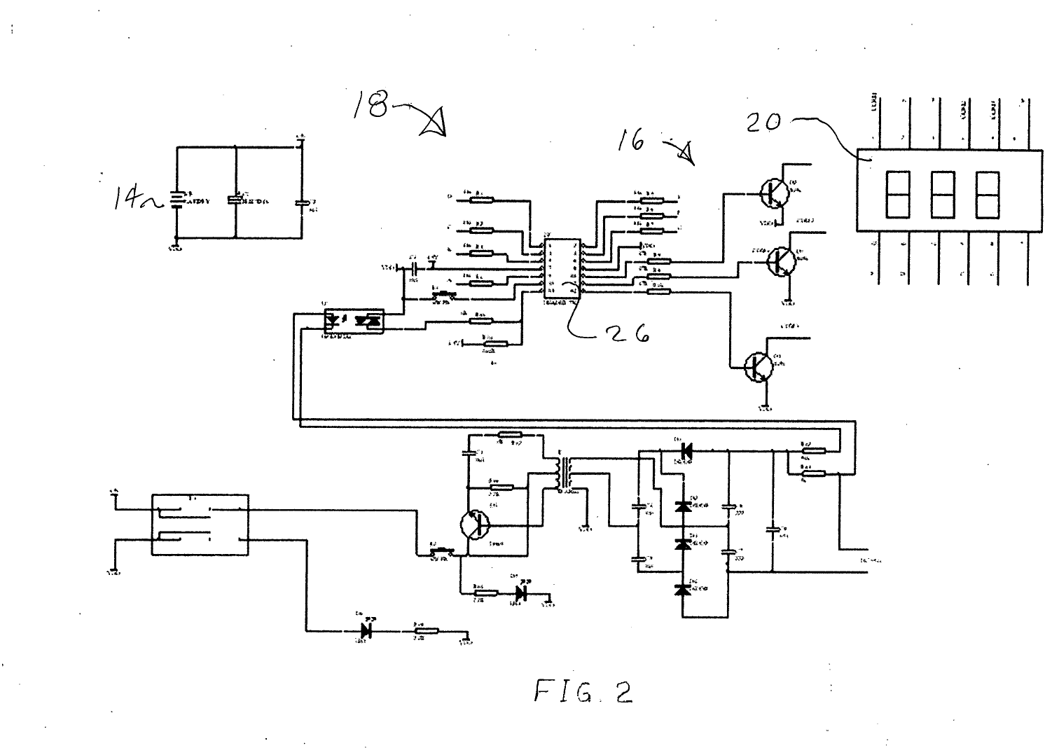

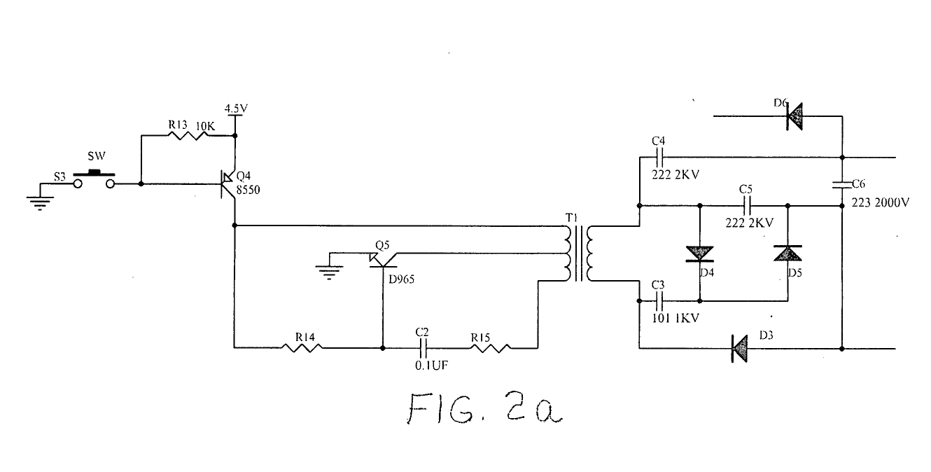

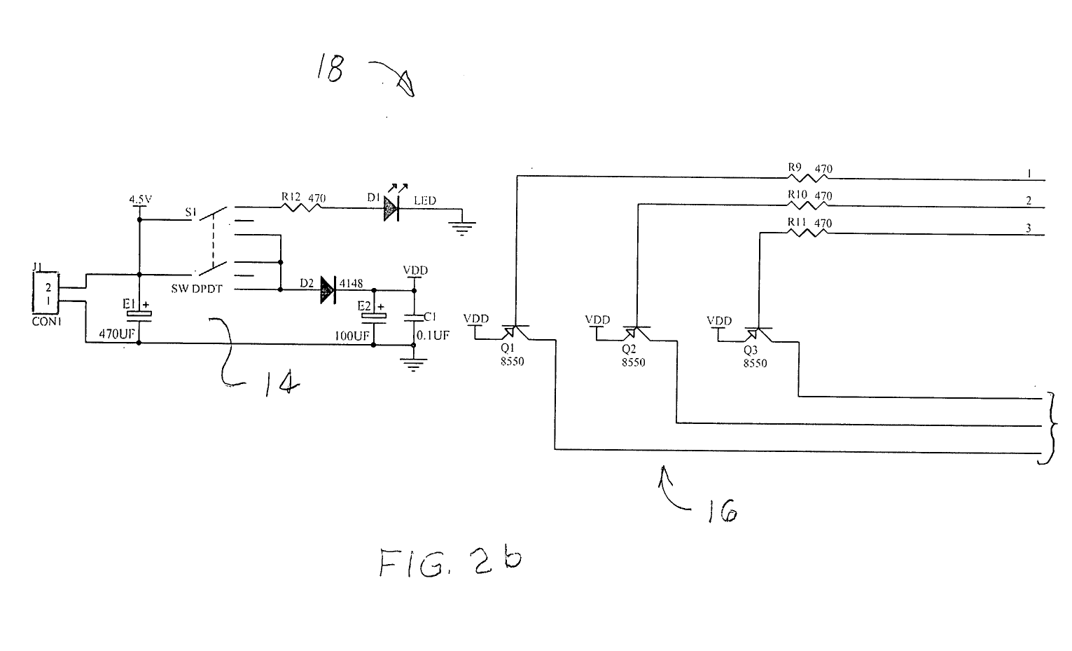

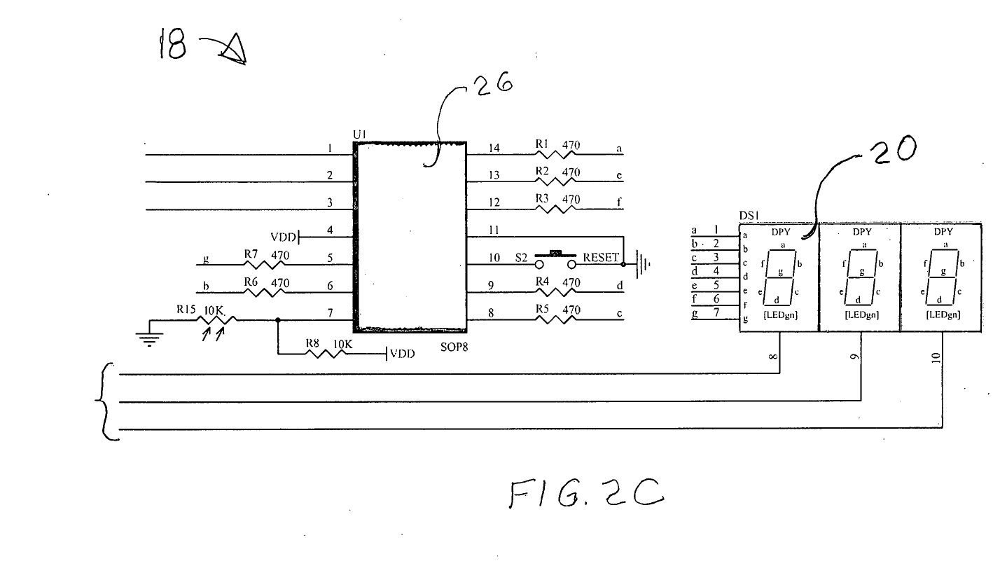

Referring now to the drawing, both to FIG. 1 and to FIG. 2, an apparatus according to the present invention is referred to generally by reference numeral 10. Apparatus 10 is intended for hitting and killing a flying insect. Apparatus 10 includes the combination of at least one electrically conducting net 12, actually three nets in a preferred form, for hitting the flying insect, a source 14 of electric power connected to the at least one electrically conducting net, a counter 16, a transducer 18 coupled to the at least one electrically conducting net and to the counter, for indicating to the counter when the at least one electrically conducting net hits the flying insect, and a display 20 coupled to the counter for indicating the number of hits. The at least one electrically conducting net is provided sufficient electrical power to kill the flying insect upon contact. Counter 16 simply increments display 20 by one each time a flying insect is killed by the at least one net 12. Source 14 of electric power is preferably simply a couple of small batteries, such as AA batteries.

A preferred form of the apparatus further includes a frame 22 for holding the at least one electrically conducting net and a handle 24 for manually holding the apparatus, wherein the frame extends from one end of the handle.

In a preferred form of the apparatus, the counter includes a processor 26, and the apparatus further includes a manual reset 28 coupled to the processor. When the manual reset is activated, display 20 is reset to zero.

A swatter according to the present invention for use by a player for hitting a flying insect, includes the combination of a handle 24 for the player to manually hold the swatter, at least one electrically conducting net 12 forming at least one face of the swatter, for hitting the flying insect, a counter 16, a transducer 18 coupled to the at least one electrically conducting net and to the counter, for indicating to the counter when the at least one electrically conducting net hits the flying insect; and a display 20 coupled to the counter for indicating the number of hits.

In a preferred form of the swatter, the counter includes a processor 26, and the swatter further includes a manual reset 28 coupled to the processor. When the manual reset is activated, the display is reset to zero. A source 14 of electric power for operation of the processor, the display and the at least one electrically conducting net is located inside the handle. The display and the manual reset are also located on the handle.

The swatter also includes a button 30 for turning the power on or off and a discharge button 32. In one arrangement, the discharge button must be pushed after each hit in order to register the hit. The swatter can be used to kill flying insects without using the counter. Display 20 is preferably an LED display in order to save batteries and to be easily read in poor light.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the figures of the accompanying drawings is to be interpreted as illustrative and not in a limiting sense.

### SEQUENCE LISTING

Not Applicable

1. An apparatus for hitting a flying insect, comprising in combination:
at least one electrically conducting net for hitting the flying insect;
a source of electric power connected to the at least one electrically conducting net, wherein the at least one electrically conducting net is provided sufficient electrical power to kill the flying insect upon contact;
a counter;
a transducer coupled to the at least one electrically conducting net and to the counter, for indicating to the counter when the at least one electrically conducting net hits the flying insect; and
a display coupled to the counter for indicating the number of hits.

2. An apparatus according to claim 1 further comprising a frame for holding the at least one electrically conducting net and a handle for manually holding the apparatus, wherein the frame extends from one end of the handle.

3. An apparatus according to claim 2 wherein the counter comprises a processor, the apparatus further comprising a manual reset coupled to the processor, wherein when the manual reset is activated, the display is reset to zero.

4. A swatter for use by a player for hitting a flying insect, comprising in combination:
a handle for the player to manually hold the swatter;
at least one electrically conducting net forming at least one face of the swatter, for hitting the flying insect;
a counter;
a transducer coupled to the at least one electrically conducting net and to the counter, for indicating to the counter when the at least one electrically conducting net hits the flying insect; and
a display coupled to the counter for indicating the number of hits.

5. An swatter according to claim 4 wherein the counter comprises a processor, the swatter further comprising a manual reset coupled to the processor, wherein when the manual reset is activated, the display is reset to zero.

6. A swatter according to claim 5 wherein a source of electric power for operation of the processor, the display and the at least one electrically conducting net is located inside the handle.

7. A swatter according to claim 6 wherein the display and the manual reset are located on the handle.
